(19) United States
(12) Patent Application Publication
(10) Pub. No.: US 2010/0291396 A1
(43) Pub. Date: Nov. 18, 2010

(54) Polyester film that seals at low temperature for nonpolar substrates

(76) Inventors: Herbert Peiffer, Mainz (DE); Bodo Kuhmann, Runkel (DE)

Correspondence Address: PROPAT, L.L.C., 425-C SOUTH SHARON AMITY ROAD, CHARLOTTE, NC, 28211-2841, US

(21) Appl. No.: 12/778,736

(22) Filed: May 12, 2010

(30) Foreign Application Priority Data
May 18, 2009 (DE) 10 2009 021 714.2

(51) Int. Cl. B32B 27/06; B29C 47/06

(52) U.S. Cl. 428/483; 264/173.19

(57) ABSTRACT

The invention relates to a heat-sealable coextruded, biaxially oriented polyester film which is peelable with respect to nonpolar substrates, for example PS and PP, and which encompasses a base layer (B) and an outer layer (A), in which
a) the base layer (B) is mainly formed from a copolyester containing ethylene terephthalate units and ethylene isophthalate units, where the proportion of ethylene isophthalate units in the copolyester is from 3 to 15 mol %, and
b) the outer layer (A) is formed from
   30 to 95% by weight of ethylene-polar-ethylene copolymer and
   5 to 70% by weight of polyester,
   where the proportion of polar-ethylene in the copolymer is from 2.5 to 15 mol %.

The outer layer (A) polyester preferably includes an ethylene-terephthalate-ethylene-isophthalate copolyester. The film is particularly suitable as peelable film (lid film) for food or drink containers.

### CROSS-REFERENCE TO RELATED APPLICATIONS

This application claims priority to German Patent Application 10 2009 021 714.2 filed May 18, 2009 which is hereby incorporated herein by reference in its entirety.

### FIELD OF THE INVENTION

The invention relates to a coextruded, sealable, and peelable, biaxially oriented polyester film with a base layer (B), and with at least one outer layer (A) applied to said base layer (B). The outer layer (A) comprises a peelable polymer that can be sealed at low temperature and that is very susceptible to adhesion to metallic surfaces, for example rolls with metallic surfaces. The base layer (B) not only comprises polyethylene terephthalate but also comprises polyethylene isophthalate, and the film can therefore be stretched in machine direction at relatively low temperatures. The susceptibility of the film to adhesion during its production process is thus reduced. The invention further relates to a process for producing the film, and to the use of the film.

### BACKGROUND OF THE INVENTION

The food and drink industry makes widespread use of not only flexible but also rigid containers (both of these hereinafter being called substrates) with peelable lids. The lids have the function of protecting the contents from mechanical damage and dirt, and of providing a good barrier against water vapor and oxygen. The lids also have to provide easy opening to the consumer, i.e. they have to be peelable. The lids therefore bear a layer that is heat-sealable and peelable. Typical materials used for such lids are aluminum, and also polymeric materials, e.g. polyesters or polyolefins, with an appropriate heat-sealable and peelable coating.

The containers are often comprised of nonpolar polymers. Among these are in particular are polymers such as polystyrene (PS), polypropylene (PP), or polyethylene (PE). When polyester film is used as lid material in such cases, the polymers used for the heat-sealable and peelable layer generally comprise those that feature low crystallite melting points or, respectively, low softening points (Vicat softening point). However, a general disadvantage of such layers is that they are very susceptible to adhesion to metallic or ceramic surfaces during production of the lid film, for example adhesion to rolls with metallic surfaces. The susceptibility of such layers to adhesion increases sharply with the temperature of the layer or, respectively, with the temperature of the surface coming into contact with the layer. These films with very high susceptibility to adhesion can therefore be produced and processed only by using very particular processes.

Consquently, the prior art generally applies the heat-sealable and peelable layer by using what are known as off-line methods (i.e. in an additional process step downstream of film production), for example to a polyester film. This method starts by using a conventional process to produce, for example, a standard polyester film. The resultant polyester film is off-line coated with a heat-sealable and peelable layer in a coating system, in a further processing step. The heat-sealable and peelable polymer here is first dissolved in an organic solvent. The finished solution is then applied to the film by a suitable application method (knifecoater, screen roll, die). The solvent is evaporated in a drying oven downstream, and the peelable polymer remains as a solid layer on the film.

This type of off-line application of the sealable layer is relatively costly, for a number of reasons. The first reason is that the coating of the film has to take place in at least one separate step in a specific apparatus. A second reason is that the solvent evaporated has to be recondensed and reclaimed in order to minimize environmental pollution by the exhaust air. A third reason is that high monitoring costs are incurred in order to ensure that the residual solvent content in the coating is minimized.

Furthermore, there is no cost-effective process that completely removes the solvent from the coating during the drying process, particularly because there is a limit to the time that can be used for the drying procedure. Traces of solvent then remaining in the coating migrate into the foods, where they can distort flavor or even have an adverse effect on consumers' health.

There are various marketed polyester films that are heat-sealable and peelable, that are produced off-line. The polyester films differ in their structure and in the constitution of the outer layer (A). Some of the known films and laminates seal with respect to substrates such as PS, PP, and PET (polyethylene terephthalate).

A coextruded, sealable polyolefin film is described in DE-A-101 28 711 (whose United States equivalent is U.S. Pat. No. 7,144,542), and has an outer layer comprising at least 70% by weight of a co- or terpolymer which is comprised of an olefin and of unsaturated carboxylic acid or of esters thereof or of anhydride thereof. The film is described as having good adhesion with respect to PP, PE, PET, PS, PVC, PC, glass, tin-plated steel, and aluminum. Disadvantages of polyolefin film compared to polyethylene terephthalate film (PET film) are poorer barrier against oxygen, lower heat resistance, and poorer mechanical properties. By way of example, polyolefin films cannot be sealed at the industrially conventional temperatures of 160° C. and above.

U.S. Pat. No. 4,333,968 describes a polypropylene film which is longitudinally oriented and then extrusion-coated with ethylene vinyl acetate copolymer (EVA), and subsequently transversely oriented. In addition to the abovementioned disadvantages of polyolefin films, another consideration here is the low heat resistance of the EVA, with the result that film edge trimmmings arising during production cannot be reground and reused in film production.

WO 2003/033258 (whose United States equivalent is U.S. Patent Application Publication No. US 2004/245138A1) describes a lid-film laminate that is sealable and peelable. The laminate is comprised of three layers: a layer of fibrous material (e.g. paper), a polymeric oxygen-barrier layer (PET, EVOH and/or polyamide), and a sealable layer. By way of example, the last two layers are coextruded and are laminated onto the first layer. The sealable layer is comprised of a combination of ethylene-methyl acrylate copolymer (EMA), EVA and polyamide wax. The weight of the sealable layer per unit area is from 5 to 30 g/m², and this layer seals with respect to PE, PP and PS. The laminate is used as a lid in food and drink packaging, an example of an application being dairy products. The disadvantages of the laminate are not only the complicated production process but also, when comparison is made with PET films, poorer optical properties (luster) of the paper surface, and poorer printability. The laminate is moreover intrinsically not recyclable.

WO 2006/055656 (whose United States equivalent is, inter alia, Untied States Patent Application Publication No. 2006/0105186) relates to a sealable film or to a laminate with a sealable film, where the sealable layer comprises an antifogging agent. The sealable layer of the film comprises or is comprised of an ethylene copolymer or a modified ethylene copolymer, or both. The ethylene copolymer is a copolymer, a terpolymer, or a tetrapolymer, containing repeat units derived from ethylene, and containing from 5 to 50% by weight of one or more polar monomers selected from the group consisting of vinyl carboxylates, acrylic acid, alkylacrylic acid, alkyl acrylate (=acrylate), and alkylacrylic acid alkyl esters. The sealable layer, the film comprising the sealable layer and, respectively, the further layers can be manufactured by a number of processes not specified in any further detail, e.g. via production of blown film, in-line or off-line by means of various coating processes, or by means of coextrusion. Further layers mentioned are those produced from nylon, polypropylene, polyethylene, ionomers, polyethylene-vinyl acetate, polyethylene terephthalate, polystyrene, polyethylene vinyl alcohol, or polyvinylidene chloride, or from a combination of two or more of these materials.

The examples cite laminates (of thickness 63.5 μm) produced from two different types of film via adhesive lamination (and not via coextrusion). The film support used comprises a PET film, thickness 12 μm, and the sealable film used comprises a blown film comprised of 3 layers. These layers are comprised of HDPE, HDPE+LDPE, and modified EVA or EMA in the sealable layer. The mechanical properties of the film/of the laminate (film curl), and the thermal and optical properties (haze, luster) are unsatisfactory, because the laminate comprises cloudy HDPE. The production costs for the laminate are high and it moreover is not regrindable, and therefore lacks environmental compatibility. Furthermore, the films have very high adhesion to metallic or ceramic (roll) surfaces, with additional resultant problems during production of the same.

EP-A-1 471 096 (whose United States equivalent is U.S. Patent Application Publication No. US 2004/213966A1), EP-A-1 471 097 (whose United States equivalent is U.S. Patent Application Publication No. US 2005/042441A1), EP-A-1 475 228 (whose United States equivalent is U.S. Patent Application Publication No. US 2004/213967A1), EP-A-1 475 229 (whose United States equivalent is U.S. Patent Application Publication No. US 2005/019559A1), EP-A-1 471 094 (whose United States equivalent is U.S. Patent Application Publication No. US 2004/213968A1), and EP-A-1 471 098 (whose United States equivalent is U.S. Patent Application Publication No. US 2004/229060A1) describe heat-sealable polyester films which have peelability with respect to A/CPET and have an ABC structure, and which comprise, with the aim of establishing the desired peel properties in the peelable and heat-sealable outer layer, amorphous, aromatic and aliphatic copolyesters, and either from about 2 to 10% by weight of inorganic or organic particles or else a polymer incompatible with polyester, an example being norbornene/ethylene. The films feature good peel properties with respect to polar substrates, e.g. PET or PVC, but are not sealable with respect to PS and PP. They are also sometimes susceptible to adhesion or tack during production, particularly with respect to rolls with ceramic or metallic surfaces.

EP-B-1 165 317 describes a heat-sealable polyester film comprised of an amorphous heat-sealable layer and of a base layer. The heat-sealable layer comprises a copolyester which is comprised of an aliphatic and a cycloaliphatic diol, with one or more carboxylic acids. The base layer (=substrate layer) comprises a copolyester which is comprised of terephthalic acid (TPA) and of isophthalic acid (IPA), with one or more diols selected from aliphatic and cycloaliphatic diols. The films feature good sealing properties, in particular with respect to metallic substrates. However, they have inadequate peel properties with respect to metallic substrates, and they further have inadequate peel properties with respect to the substrates mentioned for lid applications, an example being PS, PP, or PE.

### SUMMARY OF ADVANTAGEOUS EMBODIMENTS OF THE INVENTION

It was therefore an object of the present invention to provide a film that is heat-sealable and peelable and which in particular features very good peel properties with respect to nonpolar substrates, and which further has little susceptibility to adhesion during its production, for example with respect to metallic and ceramic surfaces/rolls.

The term “heat-sealable” here means that a film which comprises at least one heat-sealable outer layer (A) has the property that allows it to be bonded by means of sealing jaws and application of heat (preferably from 130 to 220° C.) and pressure (preferably above 2 bar) within a certain time (preferably from 0.2 to 4 s) to itself or to a substrate, while the backing layer (=base layer (B)) does not itself become plastic during said process.

Another object was therefore to provide a film which preferably has a minimum sealing temperature less than or equal to 140° C. with respect to nonpolar substrates, particularly less than or equal to 130° C., and with particular preference less than or equal to 120° C.

The term “peelable” means that a film comprising at least one heat-sealable and peelable outer layer (A) has the property that allows it, after heat-sealing to a standard substrate, to be peeled away again from the substrate, without any occurrence of tearing or break-off of the film during that process. When the film is peeled from the substrate, the intention is that the composite comprised of heat-sealable film and substrate should part at the seam between the hot-sealable layer and the surface of the substrate.

Another object was therefore to provide a film where peelability, i.e. absence of tearing or break-off during peeling, extends over the entire sealable range (preferred minimum sealing temperature of from 140° C. up to maximum sealing temperature of 220° C.).

Another simultaneous object of the present invention was to provide peelable films which have little susceptibility to adhesion to ceramic or metallic surfaces, or to surfaces comprising metal, an example being rolls in the longitudinal stretching unit (=stretching unit for stretching of the film in machine direction (MDO)), so that it is possible to use conventional stretching units for industrial production of the film.

In summary, the film of the present invention should preferably feature the following combinations of properties:
It should be heat-sealable with respect to substrates comprised of nonpolar polymers, i.e. should have a minimum sealing temperature which is preferably less than or equal to 140° C., in particular less than or equal to 130° C., particularly preferably less than or equal to 120° C.
It should peel with respect to substrates comprised of nonpolar polymers, such as PS and PP, over the entire sealing range (preferably from 140° C. to 220° C.), i.e. peel force should be greater than or equal to 1.5 N per 15 mm of film width, preferably greater than or equal to 2 N per 15 mm of film width, and particularly preferably greater than or equal to 2.5 N per 15 mm of film width.
The film should be capable of cost-effective production. The sealable layer should have minimum susceptibility to adhesion to ceramic or metallic surfaces, or to surfaces comprising metal, an example being rolls used during longitudinal stretching, thus permitting use of conventional stretching units for industrial production of the film.
The film should moreover be capable of production at machine speeds which are conventional nowadays, such as speeds of up to 500 m/min, and should also be regrindable (recyclable).
For purposes of practical application of the film, there should moreover be good adhesion between the individual layers of the film (preferably greater than 2 N/15 mm of film width), without application of any additional adhesive.

### BRIEF DESCRIPTION OF THE DRAWINGS

FIG. 1 is a schematic illustration of a tensile measuring technique used to determine seal seam strength.

### DETAILED DESCRIPTION OF ADVANTAGEOUS EMBODIMENTS OF THE INVENTION

The foregoing objects are achieved by providing a coextruded, biaxially oriented polyester film, comprising a base layer (B) and an outer layer (A), where
a) the base layer (B) is mainly comprised of a copolyester which contains ethylene terephthalate units and ethylene isophthalate units, where the proportion of ethylene isophthalate units in the copolyester is from 3 to 15 mol %, and
b) the outer layer (A) comprises
   from 30 to 95% by weight of an ethylene-polar-ethylene copolymer and
   from 5 to 70% by weight of polyester,
   where the proportion of polar-ethylene in the copolymer is from 2.5 to 15 mol %.

Unless otherwise stated, the molar percentages given for polymers or copolymers are based on the units derived from the specified monomers within the polymer or copolymer. The same applies to the description of the structure of the actual polymers or copolymers.

Unless otherwise stated, the % by weight data here and hereinafter are based on the mass of the respective layer of the film of the invention.

The heat-sealable and peelable outer layer (A) has characteristic features. The minimum sealing temperature of this layer with respect to substrates comprised of nonpolar polymers is preferably not more than 140° C., in particular not more than 130° C., and particularly preferably not more than 120° C., and its seal seam strength with respect to the same is preferably at least 1.5 N, in particular at least 2 N, and particularly preferably at least 2.5 N (based on 15 mm of film width). The maximum sealing temperature of the heat-sealable and peelable outer layer (A) with respect to substrates comprised of nonpolar polymers is preferably 220° C., and the film obtained here is peelable with respect to substrates comprised of nonpolar polymers over the entire sealing range (from minimum sealing temperature up to maximum sealing temperature).

The film of the present invention comprises a base layer (B) and at least one outer layer (A) of the invention. The structure of the film in this case has two layers. In one preferred embodiment, the structure of the film has three or more layers. Taking the particularly preferred three-layer embodiment, it is then comprised of the base layer (B), of the outer layer (A) of the invention, and of an outer layer (C) which is opposite to the outer layer (A)—layer structure A-B-C. A four-layer embodiment of the film comprises an intermediate layer (D) between the base layer (B) and the outer layer (A) or (C).

It is preferable that the base layer (B) of the film is comprised of at least 80% by weight of thermoplastic polyester. The base layer (B) of the invention is comprised mainly (i.e. to an extent greater than 50% by weight, preferably to an extent greater than 80% by weight) of a copolyester comprised mainly from isophthalic acid units and from terephthalic acid units and from ethylene glycol units. The term “mainly” here means that the copolyester is preferably comprised of >50 mol %, particularly preferably >70 mol %, and very particularly preferably >90 mol %, of ethylene terephthalate and ethylene isophthalate units. The remainder of the monomer units derive from other aliphatic, cycloaliphatic, or aromatic diols and, respectively, dicarboxylic acids. The preferred copolyesters providing the desired properties of the film are those that are comprised exclusively of ethylene terephthalate units and of ethylene isophthalate units. The proportion of ethylene terephthalate is preferably from 85 to 97 mol %, and the corresponding proportion of ethylene isophthalate is from 3 to 15 mol %. Preference is further given to copolyesters in which the proportion of ethylene terephthalate is from 90 to 97 mol %, and the corresponding proportion of ethylene isophthalate is from 3 to 10 mol %, and very particular preference is given to copolyesters in which the proportion of ethylene terephthalate is from 92 to 97 mol %, and the corresponding proportion of ethylene isophthalate is from 3 to 8 mol %. Where amounts are stated for the dicarboxylic acids, the total amount of all of the dicarboxylic acids is 100 mol %. By analogy, the total amount of all of the diols is again 100 mol %.

For the base layer (B), it is also possible to use a mixture of various polyesters and, respectively, copolyesters.

Preferred suitable other aromatic dicarboxylic acids are benzenedicarboxylic acids, naphthalene-dicarboxylic acids (e.g. naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acids) or stilbene-x,x′-dicarboxylic acids. Among the cycloaliphatic dicarboxylic acids, mention may be made of cyclohexanedicarboxylic acids (in particular cyclohexane-1,4-dicarboxylic acid). Among the aliphatic dicarboxylic acids, the (C3-C19)-alkanediacids are particularly suitable, and the alkane moiety here can be a straight-chain or branched moiety.

Examples of suitable other aliphatic diols are diethylene glycol, triethylene glycol, aliphatic glycols of the formula HO—(CH₂)ₙ—OH, where n is an integer from 3 to 6 (particularly propane-1,3-diol, butane-1,4-diol, pentane-1,5-diol, and hexane-1,6-diol) or branched aliphatic glycols having up to 6 carbon atoms, or cycloaliphatic diols which have one or more rings and which, if appropriate, contain heteroatoms. Among the cycloaliphatic diols, cyclohexanediols (in particular cyclohexane-1,4-diol) may be mentioned. Examples of other further diols include aromatic diols, exemplary suitable aromatic diols are those of the formula HO—C₆H₄—X—C₆H₄—OH, where X is —CH₂—, —C(CH₃)₂—, —C(CF₃)₂—, —O—, —S—, or —SO₂—. Bisphenols of the formula HO—C₆H₄—C₆H₄—OH also have good suitability.

The polyesters of the invention can be produced by the transesterification process. This process starts from dicarboxylic esters and diols, and these are reacted with the usual transesterification catalysts, for example salts of zinc, of calcium, of lithium, of magnesium, and of manganese. The intermediates are then polycondensed in the presence of well-known polycondensation catalysts, examples being antimony trioxide, titanium oxides, or esters, or else germanium compounds and aluminum compounds. An equally good production process is direct esterification in the presence of polycondensation catalysts. This process starts directly from the dicarboxylic acids and from the diols.

The selection of the polymers for the base layer (B) in the invention gives a marked improvement in ease of production of the peelable film, which intrinsically is susceptible to adhesion. Selection of the specific polymers for the base layer (B) in the invention in particular markedly reduces susceptibility of the film to adhesion during longitudinal stretching, in which the film is stretched in machine direction. Stretching temperatures can be lowered significantly, while other stretching conditions are unaltered. The temperatures for the longitudinal stretching process (heating and stretching temperatures) can be reduced by an amount in the range from 5 to 25° C. in comparison with a standard polyester film that uses polyethylene terephthalate in the base layer (B), and this gives a marked reduction in the susceptibility of the film to adhesion during its production.

It has been found that (if the constitution of the peelable outer layer (A) is the same, i.e. constant) the substantial variables that affect susceptibility of the film to adhesion are the process parameters in the longitudinal stretching process. Among the process parameters are in particular the stretching temperature T_{MD}, the stretching ratio λ_{MD}, the film web speed, and possibly the nature of the stretching process (MD=longitudinal stretching, or stretching in machine direction).

Examples of conventional values for the parameters mentioned in the case of films not of the invention are:

| | |
|---|---|
| Heating temperatures | from 60 (entry to heating system) to 120° C. |
| | (exit from heating system) |
| Stretching temperatures | from 100 to 115° C. |
| Stretching ratios | from 3.0 to 5.0 |

For the films of the invention, in contrast—by virtue of the specific constitution of the base layer (B)—the temperatures and stretching ratios are within ranges given in the following table:

| | |
|---|---|
| Heating temperatures | from 60 (entry to heating system) to 95° C. |
| | (exit from heating system) |
| Stretching temperatures | from 75 to 95° C. |
| Stretching ratios | from 2.0 to 4.5 |

In the case of the longitudinal stretching process, the specified data are based on what is known as NTEP stretching, which is constituted from a stretching step providing a low level of orientation (LOE=Low Orientation Elongation) and a stretching step providing a high level of orientation (REP=Rapid Elongation Process). The conditions provided by other stretching units are in principle the same, with the possibility of small differences in the numeric values for the respective process parameters. The stated temperatures are based on the respective roll temperatures, measured using IR.

If the concentrations of the invention are used for the ethylene terephthalate units and ethylene isophthalate units in the copolymer of the base layer (B), the film has been found to be capable of problem-free production in a dependable process that uses the specified low stretching temperatures, and a particular reason for this is that at these relatively low stretching temperatures, in comparison with the prior art, a film has markedly reduced susceptibility to adhesion, without any alteration of the peel layer (A).

In contrast, if the base layer (B) uses a polymer in which the proportion of ethylene isophthalate in the copolymer is less than 3 mol %, it becomes impossible to produce the film in a dependable process at the low longitudinal stretching temperatures required in order to make the outer layer (A) less susceptible to adhesion. Frequent break-offs of the film occur during the longitudinal stretching process, and in the most disadvantageous case the film wraps around the stretching rolls, which then have to be replaced.

On the other hand, if the proportion of ethylene isophthalate in the copolymer of the base layer (B) is increased above the range of the invention, the result is undesirable, in that the film loses its mechanical properties. Another result here is increased shrinkage of the film, and this is likewise undesirable.

In order to achieve the peel properties desired, the sealable and peelable outer layer (A), which is applied via coextrusion, is comprised of a polymer with low softening point. The Vicat softening point of the peelable outer layer (A) is preferably below 70° C., particularly preferably below 65° C., and very particularly preferably below 60° C., according to the invention. If the Vicat softening point of the peelable outer layer (A) is above 70° C., the film loses the peel properties of the invention.

The sealable and peelable outer layer (A) is comprised of at least 30% by weight, preferably at least 35% by weight, and particularly preferably 40% by weight, of an ethylene-polar-ethylene copolymer. The maximum proportion of the ethylene-polar-ethylene copolymer in the sealable and peelable outer layer (A) is 95% by weight, preferably 90% by weight, and particularly preferably 85% by weight.

If the proportion of the ethylene-polar-ethylene copolymer in the sealable and peelable outer layer (A) is less than 30% by weight, the peel force required for lid opening is not achieved. On the other hand, if the maximum proportion of the ethylene copolymer in the sealable and peelable outer layer (A) is more than 95% by weight, the adhesion of the outer layer (A) to the base layer (B) or to an intermediate layer (D) located between (B) and (A) is too small. The result is undesirable, in that the outer layer (A) delaminates from the base layer (B) on peeling.

“Polar-ethylene” in the invention means a monomer unit comprised of an ethylene unit and of one or more polar groups. The copolymer is then comprised of “pure” ethylene units and of polar-ethylene units corresponding to the formula

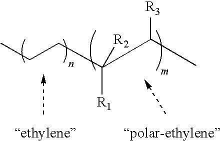

where
R₁ is C₁-C₃-alkoxycarbonyl or
   —CO—OR₄, where
   R₄ is hydrogen, linear or branched C₁-C₁₈-alkyl which in turn, if appropriate, has single, double, triple, or multiple substitution by OH or by phenyl, C₅-C₁₂-cycloalkyl which, if appropriate, has bridging by a C₁-C₃ bridge, and/or which has single, double, or multiple substitution by lower alkyl,
      or is phenyl, or
      —(CH₂—CH₂—O)_{q}—R₅, where
      R₅ is hydrogen, C₁-C₂₄-alkyl or phenyl, where the phenyl can in turn have single, double, or multiple substitution by C₁-C₁₂-alkyl, and
      q is the degree of polymerization of the —(CH₂—CH₂—O)_{q}—R₅ moiety,
R₂ is hydrogen or lower alkyl,
R₃ is —COOR₆ or hydrogen, where
   R₆ is hydrogen or a lower alkyl radical, and
n and m are identical or different integers, where the sum n+m corresponds to the degree of polymerization of the ethylene-polar-ethylene copolymer.

Preference is given to copolymers in which
R₁ is methoxycarbonyl or
   —CO—OR₄, where
   R₄ is hydrogen, linear or branched C₁-C₁₈-alkyl which in turn, if appropriate, has single substitution by OH or by phenyl, or triple substitution by OH, C₅-C₆-cycloalkyl which, if appropriate, has bridging by a C₁ bridge and/or has substitution by lower alkyl,
      or is phenyl, or
      —(CH₂—CH₂—O)_{q}—R₅, where
      R₅ is hydrogen, methyl, C₂₋₂-alkyl, or phenyl, where the phenyl can in turn have substitution by C₇-C₉-alkyl, and
      q is the degree of polymerization of the —(CH₂—CH₂—O)_{q}—R₅ moiety,
R₂ is hydrogen or methyl,
R₃ is —COOR₆ or hydrogen, where
   R₆ is hydrogen or a lower alkyl moiety, and
n and m are identical or different integers, where the sum n+m corresponds to the degree of polymerization of the ethylene-polar-ethylene copolymer.

“Lower alkyl” means a methyl, ethyl, propyl, isopropyl, butyl, isobutyl, or tert-butyl moiety.

The proportion of polar-ethylene repeat units in the ethylene-polar-ethylene copolymer is preferably from 2.5 to 15 mol %, in particular from 3 to 12 mol %, and particularly preferably from 5 to 11 mmol %.

Examples of these polar-ethylene monomers or polar-ethylene repeat units include vinyl-acetate, acrylic acid, methacrylic acid, ethyl acrylate, ethyl methacrylate, methyl acrylate, methyl-methacrylate, propyl acrylate, propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, n-hexyl acrylate, n-hexyl methacrylate, n-octyl acrylate, n-octyl methacrylate, 2-octyl acrylate, 2-octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, cyclohexyl acrylate, cyclohexyl methacrylate, benzyl acrylate, benzyl methacrylate, phenyl acrylate, phenyl methacrylate, 2-hydroxyethyl acrylate, 2-hydroxyethyl methacrylate, glycidyl acrylate, glycidyl methacrylate, poly(ethylene glycol) acrylate, poly(ethylene glycol) methacrylate, poly(ethylene glycol) methyl ether acrylate, poly(ethylene glycol) methyl ether methacrylate, poly(ethylene glycol) behenyl ether acrylate, poly(ethylene glycol) behenyl ether methacrylate, poly(ethylene glycol) 4-nonylphenyl ether acrylate, poly(ethylene glycol) 4-nonylphenyl ether methacrylate, poly(ethylene glycol) phenyl ether acrylate, poly(ethylene glycol) phenyl ether methacrylate, dimethyl maleate, diethyl maleate, dibutyl maleate, dimethyl fumarate, diethyl fumarate, and dibutyl fumarate, preference being given here to those containing vinyl acetate, acrylic acid, methacrylic acid, or alkyl (meth)acrylate, or a combination of two or more thereof.

The ethylene-polar-ethylene copolymers used in the invention are either available commercially per se or can easily be produced by using processes familiar to the person skilled in the art, examples being processes as described in WO 06/055656.

The sealable and peelable outer layer (A) in the invention comprises an amount of polyester in the range from 5 to 70% by weight, preferably from 10 to 65% by weight, and particularly preferably from 15 to 60% by weight, alongside the ethylene-polar-ethylene copolymers.

If the proportion of the polyester in the sealable and peelable outer layer (A) is less than 5% by weight, the adhesion of the outer layer (A) is too low, for example in respect of the base layer (B). The outer layer (A) then delaminates from the base laser (B) during the peeling process, and this is undesirable. If the proportion of the polyester in the sealable and peelable outer layer (A) is more than 70% by weight, the peel force demanded with respect to PS and PP becomes impossible to achieve.

The type of polyester selected is generally the same as previously described for the base layer (B). By way of example here, the polyester is selected from the group of PET, IPA (polyester copolymer based on terephthalate and isophthalate), and mixtures thereof.

It is particularly advantageous to use a polyester that is based mainly on copolyesters which are mainly comprised of isophthalic acid units and terephthalic acid units, and of ethylene glycol units. The remaining monomer units derive from other aliphatic, cycloaliphatic, or aromatic diols and, respectively, dicarboxylic acids that can also occur in the base layer. The preferred copolyesters providing the desired sealing properties and the desired peel properties are those comprised of ethylene terephthalate units and of ethylene isophthalate units, and of ethylene glycol units. The proportion of ethylene terephthalate here is generally from 60 to 95 mol %, and the corresponding proportion of ethylene isophthalate is from 40 to 5 mol %. In preferred copolyesters, the proportion of ethylene terephthalate is from 65 to 90 mol %, and the corresponding proportion of ethylene isophthalate is from 35 to 10 mol %; in copolyesters to which most preference is given, the proportion of ethylene terephthalate is from 70 to 85 mol %, and the corresponding proportion of ethylene isophthalate is from 30 to 15 mol %.

There is another advantageous effect on the ease of production of the film that results from the addition of polyester to the sealable and peelable outer layer (A). Addition of polyester also reduces susceptibility of the outer layer (A) to adhesion to metallic rolls, which is intrinsically very high, and this reduction is extremely desirable.

The outer layer (A) is comprised mainly of the copolymer and polyester described. The term “mainly” means that they are preferably comprised of at least 90% by weight of said polymers. Up to 10% by weight of additives can be present in this layer.

The heat-sealable and peelable outer layer (A) can also comprise inorganic and/or organic particles (which are also termed “pigments” or “antiblocking agents”), at a concentration of preferably from 0.5 to 10% by weight, based on the mass of the outer layer (A). In one preferred embodiment, the outer layer (A) comprises a concentration of from 0.7 to 9% by weight of inorganic and/or organic particles. In one particularly preferred embodiment, the outer layer (A) comprises a concentration of from 1.0 to 8% by weight of inorganic and/or organic particles.

Usual particles are inorganic and/or organic particles such as calcium carbonate, amorphous silica, talc, magnesium carbonate, barium carbonate, calcium sulfate, barium sulfate, lithium phosphate, calcium phosphate, magnesium phosphate, aluminum oxide, lithium fluoride, the calcium, barium, zinc, or manganese salts of the dicarboxylic acids used, titanium dioxide, kaolin, or crosslinked polystyrene particles, or crosslinked acrylate particles. The particles can be added in the respective advantageous concentrations to the layer, for example in the form of glycolic dispersion, during the polycondensation reaction, or by way of masterbatches during extrusion.

Particles preferred by the invention are synthetically produced, amorphous SiO₂ particles in colloidal form. These particles give exceptionally good binding into the polymer matrix and produce only few vacuoles (cavities). Vacuoles are produced at the particles during biaxial orientation, and generally cause haze, and are therefore undesirable in the present invention. Examples of suitable particles can be purchased from the companies Grace, Fuji, Degussa or Ineos.

The median diameter d₅₀ of the particles is advantageously from 2 to 15 μm. The medium diameter d₅₀ of the particles in another preferred embodiment is from 2.5 to 15 μm, and the median diameter d₅₀ of the particles in one particularly preferred embodiment is from 3.0 to 15 μm.

To obtain a further improvement in the processing performance of the film of the present invention, an advantageous ratio of particle diameter to layer thickness is in the range from 0.2 to 2.0, preferably in the range from 0.25 to 1.8, and particularly preferably in the range from 0.3 to 1.5.

It is moreover advantageous likewise to incorporate particles into the base layer (B) of a two-layer film structure (AB), or into the preferably non-sealable outer layer (C) of a three-layer film structure (ABC).

In the two-layer embodiment, and in the particularly advantageous three-layer embodiment, of the film of the invention, the thickness of the outer layer (A) is preferably in the range from 2 to 20 μm, in particular in the range from 3 to 19 μm, and particularly preferably in the range from 4 to 18 μm. However, if the thickness of the outer layer (A) is less than 2 μm, the heat-sealability of the film with respect to PS and PP is diminished or lost.

The thickness of the other, preferably non-sealable, outer layer (C) can be the same as that of the outer layer (A) or can differ therefrom, generally being from 1 to 20 μm. The constitution of the layer (C) generally differs from that of the layer (A). It is comprised mainly of thermoplastic polyester or copolyester, in particular mainly of PET.

The total thickness of the polyester film of the invention can vary within certain limits. It is preferably from 5 to 500 μm, particularly from 10 to 450 μm, and preferably from 15 to 400 μm, the proportion made up here by the layer (B) preferably being from 45 to 97%, based on total thickness.

In one preferred embodiment of the film of the present invention, the base layer (B) comprises a concentration of preferably from 3 to 20% by weight, with preference from 4 to 18% by weight, of at least one whitening pigment. The concentration selected by the invention here is such that the Berger whiteness of the film is preferably greater than 70%. Otherwise, the optical properties of the film are less suitable for the applications intended (e.g. sealed lid film on pots) because the film is too translucent.

For achievement of the abovementioned properties, in particular of the desired whiteness of the film, it is preferable that the necessary pigments are incorporated not only into the base layer (B) but also into the optional outer layer (C). Examples of those that can be used are titanium dioxide, calcium carbonate, barium sulfate, zinc sulphide, or zinc oxide. It is preferable to use TiO₂ as sole whitening pigment. It is preferably added in the form of extruded masterbatch (with the concentration of titanium dioxide markedly higher within the masterbatch than that in the biaxially oriented film) to the original polymer. A typical concentration of TiO₂ in the extruded master batch is 50% by weight of titanium dioxide. The titanium dioxide can be of either rutile type or anatase type. It is preferable to use titanium dioxide of rutile type. The grain size of the titanium dioxide is generally from 0.05 to 0.5 μm, preferably from 0.1 to 0.3 μm. The pigments incorporated give the film a brilliant white appearance. For achievement of the desired whiteness (preferably >70%) and the desired low transparency (preferably <50%), the filler content in the base layer (B) should be high. The concentration of particles needed to achieve the desired low transparency is preferably greater than or equal to 3% by weight, but less than or equal to 20% by weight, preferably above 4% by weight, but below 18% by weight, based on the total weight of the base layer (B).

In order to achieve a further increase in whiteness, appropriate optical brighteners can be added to the base layer and/or to the other layers. An example of a suitable optical brightener is HOSTALUX® KS (Clariant, Del.) or EASTOBRITE® OB-1 (Eastman, USA).

It has been found that the preferred use of in essence TiO₂ as whitening pigment gives the film less susceptibility to tearing and delamination. The TiO₂ added, preferably by way of master batch technology, has the advantage that it is relatively easy to correct color differences, for example those due to inconsistent reground properties. Use of TiO₂ as sole pigment makes the film particularly smooth and thus more glossy, but may possibly make it susceptible to blocking.

The base layer and the other layers can also comprise conventional additives, e.g. stabilizers (UV, hydrolysis), flame-retardant substances, or fillers. It is advantageous that these are added to the polymer or to the polymer mixture prior to the start of the melting process. The optional outer layer (C) can in particular comprise coloring pigments and/or antiblocking agents, preferably at the concentrations given for the layers (B) and (A).

The invention also provides a process for producing the polyester film of the invention by extrusion processes or coextrusion processes known per se from the literature (“Handbook of Thermoplastic Polyesters, ed. S. Fakirov, Wiley-VCH, 2002”, or in the chapter on “Polyesters, Films” in “Encyclopaedia of Polymer Science and Engineering, vol. 12, John Wiley & Sons, 1988”).

The procedure for the purposes of this process is that the melts corresponding to the film layers are coextruded through a flat-film die, the resultant film is drawn off on one or more rolls for solidification, and the film is then biaxially stretched (oriented), and the biaxially stretched film is heat-set and, if appropriate, also corona- or flame-treated on the surface layer intended for treatment.

The biaxial stretching (orientation) process is generally carried out sequentially, and preference is then given here to the sequential biaxial stretching process in which the material is first stretched longitudinally (in machine direction) and is then stretched transversely (perpendicularly to machine direction).

As is conventional in the extrusion process, the polymer or polymer mixture for the film is firstly compressed and plastified in an extruder, and any additives provided as additions here can by this stage be present in the polymer or in the polymer mixture. The melt is then forced through a flat-film die, and the extruded melt is drawn off on one or more cooled take-off rolls, whereupon the melt cools and solidifies to give a prefilm. This applies by way of analogy to the various layers of the film in the coextrusion process, these being mutually superposed by simultaneous forcing/coextrusion through an appropriate flat-film die.

The biaxial stretching process is generally carried out sequentially. This process preferably begins by longitudinal stretching of the prefilm (i.e. in machine direction=MD), which is then stretched transversely (i.e. perpendicularly to machine direction=TD). This results in spatial orientation of the polymer chains. The longitudinal stretching process can be carried out with the aid of two rolls rotating at different speeds corresponding to the desired stretching ratio. An appropriate tenter frame is generally used for the transverse stretching process, and in this frame the film is clamped at both edges and then drawn toward the two sides at an elevated temperature.

The temperatures at which the biaxial stretching process is carried out depend particularly, in the case of the longitudinal stretching process, on the properties of the sealable and peelable outer layer (A). The invention carries out the longitudinal stretching process at a temperature in a range which is preferably from 60 to 95° C., the heating temperatures being in the range from 60 to 95° C. and the stretching temperatures being in the temperature range from 75 to 95° C. The temperature used for the transverse stretching process can vary relatively widely and depends on the properties desired in the film. It is preferably in the temperature range from 90° C. (start of stretching process) to 140° C. (end of stretching process). The longitudinal stretching ratio is generally in the range from 2:1 to 4.5:1, preferably from 2.1:1 to 4:1 and particularly preferably from 2.2:1 to 3.5:1. The transverse stretching ratios are generally in the range from 3:1 to 5:1, preferably from 3.5:1 to 4.5:1.

In the heat-setting process that follows, the film is kept at a temperature in the range from 150 to 250° C. for a period which is from about 0.1 to 10 s. The film is then taken up or wound in the usual way, such as wound on a roll.

After the biaxial stretching process, the non-sealable side of the film (optional layer (C)) can be corona- or flame-treated by one of the known methods. The intensity of treatment is adjusted so as to give surface tension in the range above 45 mN/m.

The film can also be coated in order to achieve other desired properties. Typical coatings are those with adhesion-promoting, antistatic, slip-improving, hydrophilic, or release effect. These additional layers can, of course, be applied to the film by use of in-line coating, using aqueous dispersions, after the longitudinal stretching step and prior to the transverse stretching step.

The gloss of surface (B) of the film in the case of a two-layer film, or the gloss of the surface (C) of the film in the case of a three-layer film, is preferably greater than 40 (measured according to DIN 67530 by analogy with ASTM-D523-78 and ISO 2813 with 20° angle of incidence). In one preferred embodiment, the gloss of these sides is more than 50, and in one particularly preferred embodiment it is more than 60. These surfaces of the film are therefore particularly suitable for a further functional coating, or for printing, or for metallization.

The film of the invention has excellent suitability for the packaging of foods and other consumable items, in particular for the packaging of dairy products in pots, and for the packaging of ready meals in trays, where peelable polyester films are used to open the package.

The table below (Table 1) once again collates the preferred properties of the film:

TABLE 1

| | | | | |
|---|---|---|---|---|
| | | Very | | |
| | Particularly | particularly | | |
| Preferred | preferred | preferred | Unit | Test method |

Outer layer (A)

| | | | | | |
|---|---|---|---|---|---|
| Proportion of ethylene-polar-ethylene copolymer | 30 to 95 | 35 to 90 | 40 to 85 | % by wt. | |
| Proportion of polyester | 5 to 70 | 10 to 65 | 15 to 60 | % by wt. | |
| Proportion of polar-ethylene in copolymer | 2.5 to 15 | 3 to 12 | 5 to 11 | mol % | |
| Vicat softening point | ≦70 | ≦65 | ≦60 | ° C. | DIN EN ISO |
| | | | | | 306 |
| Thickness of outer layer (A) | 2 to 20 | 3 to 19 | 4 to 18 | μm | |

Base layer (B)

| | | | | |
|---|---|---|---|---|
| Proportion of ethylene terephthalate/copolyester | 85 to 97 | 90 to 97 | 92 to 97 | mol % |
| Proportion of ethylene isophthalate/copolyester | 3 to 15 | 3 to 10 | 3 to 8 | mol % |

Properties of film

| | | | | |
|---|---|---|---|---|
| Thickness of film | 5 to 500 | 10 to 450 | 15 to 400 | μm |
| Minimum sealing temperature of outer layer (A) with | ≦140 | ≦130 | ≦120 | ° C. |
| respect to standard substrates (for film of thickness 60 μm) | | | | |
| Peel force of outer layer (A) with respect to standard | ≧1.5 | ≧2.0 | ≧2.5 | N/15 mm |
| substrates (for film of thickness 60 μm) | | | | |
| Adhesion between Outer layer (A) and base layer (B) | >1.5 | >2.0 | >2.5 | N/15 mm |

The following test methods were used for the purposes of the present invention, to characterize the raw materials and the films:

Measurement of Median Diameter d₅₀

The median diameter d₅₀ of the antiblocking agent is determined by means of a laser, using laser scanning in a Malvern MASTERSIZER® (Malvern Instruments, Ltd., GB) (an example of other test equipment being the Horiba LA® 500 or the Sympathec HELOS® (Sympathec GmbH, DE), which use the same principle of measurement). For the tests, the specimens are placed with water in a cell, and this is then placed in the test equipment. A laser scans the dispersion, and the particle size distribution is determined from the signal, by comparison with a calibration curve. The measurement procedure is automatic and also includes mathematical determination of d₅₀ value. d₅₀ value is defined here as being determined as follows from the (relative) cumulative particle size distribution curve: the desired d₅₀ value (also termed median) is given on the abscissa axis by the intersection of the 50% ordinate value with the cumulative curve.

### SV Value

The SV value of the polymer is determined by measuring relative viscosity (ηᵣₑₗ) of a 1% strength solution in dichloroacetic acid in a Ubbelohde viscometer at 25° C. The SV value is defined as follows:

SV=(ηᵣₑₗ−1)·1000.

### Seal Seam Strength (Peel Force)

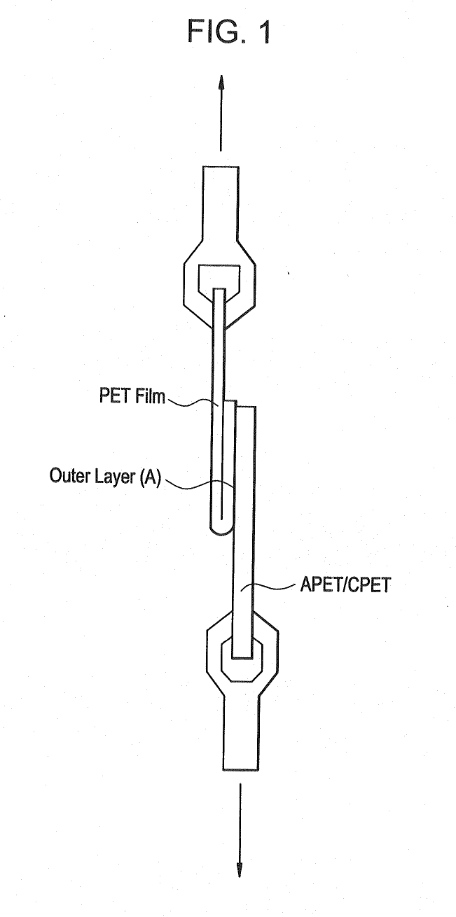

For determination of seal seam strength, a strip of film (100 mm long and 15 mm wide) is placed on an appropriate substrate comprised of PS or PP, and is sealed at the set temperature of >130° C., with a sealing time of 1.0 s and with a sealing pressure of 4 bar (HSG/ET® sealing equipment from Brugger (Munich, DE), single-side heated sealing jaws). The sealed strips are pulled apart at an angle of 180° (cf. FIG. 1) after cooling to room temperature, and the force needed is determined, the peel speed used being 200 mm/min. Seal seam strength is stated in N per 15 mm of film strip (e.g. 3 N/15 mm). FIG. 1 shows the arrangement of peelable film (1) with outer layer (A) (2) and PS strip (3) (e.g. of a yoghurt pot) in the tensile test equipment.

### Determination of Minimum Sealing Temperature

Heat-sealed specimens (seal seam 15 mm×100 mm) were produced with Brugger HSG/ET® sealing equipment, as described above for measurement of seal seam strength, but the film is sealed at various temperatures with the aid of single-side heated sealing jaws at a sealing pressure of 4 bar, for a sealing time of 1 s. 180° seal seam strength (cf. FIG. 1) is measured as in the determination of seal seam strength. The minimum sealing temperature is the temperature at which a seal seam strength of at least 0.5 N/15 mm is achieved.

### Haze

Haze is determined to ASTM-D1003-52.

### Gloss

Film gloss is determined to DIN 67530. The reflectance value is measured, this being a characteristic optical value for a film surface. Angle of incidence is set at 20°, by analogy with the standards ASTM-D523-78 and ISO 2813. A beam of light at the set angle of incidence hits the flat test surface and is reflected and/or scattered thereby. A proportional electrical variable is displayed representing light rays hitting the photoelectronic detector. The value measured is dimensionless and must be stated with the angle of incidence.

### Whiteness

Whiteness is determined by the Berger method, the general method being that more than twenty layers of film are mutually superposed. Whiteness is determined with the aid of an ELREPHO® electrical reflectance photometer from Zeiss, Oberkochem (DE), standard illuminant C, 2° standard observer. Whiteness is defined as WG=RY+3RZ−3RX. WG=whiteness, RY, RZ, RX=appropriate reflection factors using the Y, Z and X color-measurement filter. The whiteness standard used comprises a barium sulfate pressing (DIN 5033, part 9). A detailed description is given by way of example in Hansl Loos “Farbmessung” [Color measurement], Beruf und Schule edition, Itzehoe (1989).

### Melt Index (MFI)

Melt index is measured to DIN EN ISO 1133 at 190° C., the applied weight being 2.16 kg, the data are stated in g/10 min.

### Vicat Softening Point

Vicat softening point is determined to DIN EN ISO 306 on a test specimen with chemical constitution the same as that of the sealable outer layer (A). The usual procedure for producing the test specimen starts by using a twin-screw extruder (with devolatilization) to produce pellets from the mixture of polymer with additive. The pellets are then used for injection-moldings of the test specimens in a further step.

Examples are used below for detailed illustration of the invention, but this is not restricted thereto.

### Example

Chips comprised of ethylene terephthalate-ethylene isophthalate copolyester having 95 mol % of ethylene terephthalate and 5 mol % of ethylene isophthalate were introduced into the extruder for the base layer (B). Alongside this, chips comprised of polyethylene terephthalate and particles were introduced into the extruder (twin-screw extruder) for the non-sealable outer layer (C). The process conditions listed in the table below were used for melting and homogenizing of the raw materials in the two respective extruders.

Alongside this, a mixture comprised of 80% by weight of ethylene-methacrylate copolymer (LOTRYL® 24 MA07 from Arkema, Del.) and of 20% by weight of polyester was introduced into a twin-screw extruder with devolatilizing apparatus for the sealable and peelable outer layer (A). The process conditions listed in the table below were used for the melting of the raw material in the twin-screw extruder.

Layers of the three melt streams were then mutually superposed via coextrusion in a three-layer die, and were discharged by way of the die lip. The resultant melt film was cooled, and a transparent, three-layer film of ABC structure, total thickness 60 μm, was produced by stepwise longitudinal and transverse orientation, followed by heat setting. The thickness of the outer layer (A) was 10 μm, and that of the outer layer (C) was 2 μm.

### Outer Layer (A)

80% by weight of ethylene-methyl acrylate copolymer (LOTRYL® 24 MA07 from Arkema, Düsseldorf, DE) having a proportion of 9.4 mol % (corresponding to about 24% by weight) of methyl acrylate, with melt index (MFI 2.16/190° C.) of 7 g/10 min
20% by weight of polyester (=copolymer comprised of 78 mol % of ethylene terephthalate, 22 mol % of ethylene isophthalate) with SV of 850. The glass transition temperature of the polyester is about 75° C.

### Base Layer (B)

100% by weight of ethylene terephthalate-ethylene isophthalate copolyester having 95 mol % of ethylene terephthalate and 5 mol % of ethylene isophthalate with SV of 800.

### Outer Layer (C), a Mixture Comprised of

85% by weight of polyethylene terephthalate with SV of 800
15% by weight of masterbatch comprised of 99% by weight of polyethylene terephthalate (SV of 800) and 1.0% by weight of SYLOBLOC® 44 H (synthetic SiO₂, Grace, Worms, Del.), d₅₀=2.5 μm

The production conditions in the individual steps of the process were:

| | | | | |
|---|---|---|---|---|
| Extrusion | Temperatures | Layer A: | 280 | ° C. |
| | | Layer B: | 280 | ° C. |
| | | Layer C: | 280 | ° C. |
| | Temperature of take-off roll | | 25 | ° C. |
| Longitudinal | Heating temperature | | 70-90 | ° C. |
| stretching | | | | |
| | Stretching temperature | | 85 | ° C. |
| | Longitudinal stretching ratio | | 3.0 | |
| Transverse | Heating temperature | | 105 | ° C. |
| stretching | | | | |
| | Stretching temperature | | 135 | ° C. |
| | Transverse stretching ratio | | 4.0 | |
| Setting | Temperature | | 230 | ° C. |
| | Duration | | 3 | s |

The film was capable of entirely satisfactory production, and no adhesion of the film on the longitudinal stretching rolls was observed.

Table 2 shows the minimum sealing temperatures and the seal seam strengths for the film with respect to PS and PP. For the seal seam strength test, the film was sealed at 180° C. with respect to PS and PP (sealing pressure 4 bar, sealing time 1.0 s). Strips of the composite comprised of film of the invention and substrate were then subjected to peeling in accordance with the abovementioned test specification. The desired peeling of the film from the substrate was apparent in every case.

TABLE 2

| | PS | PP | Unit |
|---|---|---|---|
| Minimum sealing | 100 | 102 | ° C. |
| temperatures | | | |
| Seal seam strength | 7.8 | 6.5 | N/15 mm |

### Comparative Example 1

The Example was repeated under modified conditions. Polyethylene terephthalate was used instead of the ethylene terephthalate-ethylene isophthalate copolyester in the base layer (B). The parameter set used here for longitudinal stretching was as follows:

| | | | | |
|---|---|---|---|---|
| Extrusion | Temperatures | Layer A: | 280 | ° C. |
| | | Layer B: | 280 | ° C. |
| | | Layer C: | 280 | ° C. |
| | Take-off roll temperature | | 25 | ° C. |
| Longitudinal | Heating temperature | | 70-110 | ° C. |
| stretching | | | | |
| | Stretching temperature | | 105 | ° C. |
| | Longitudinal stretching ratio | | 3.5 | |

Sticking of the film occurred comparatively frequently during the longitudinal stretching process, and during this process the film wound around the stretching roll several times, with a resultant production stoppage. The rolls within the longitudinal stretching section had to be replaced and cleaned because of adherent polymer residues from the outer layer (A). This is attended by a large loss of cost-effectiveness.

That which is claimed is:

1. A coextruded, biaxially oriented polyester film comprising a base layer B and an outer layer A, in which
i) the base layer B is mainly comprised of a copolyester which contains ethylene terephthalate units and ethylene isophthalate units, where the proportion of ethylene isophthalate units in the copolyester is from 3 to 15 mol %, and
ii) the outer layer A comprises
from 30 to 95% by weight of ethylene-polar-ethylene copolymer and
from 5 to 70% by weight of polyester,
where the proportion of polar-ethylene in the copolymer is from 2.5 to 15 mol %.

2. The polyester film as claimed in claim 1, wherein the base layer B comprises at least 80% by weight of the copolyester.

3. The polyester film as claimed in claim 2, wherein the base layer B comprises 100% by weight of the copolyester.

4. The polyester film as claimed in claim 1, wherein the base layer B further comprises a concentration of from 3 to 20% by weight of a whitening pigment.

5. The polyester film as claimed in claim 4, wherein the base layer B comprises titanium dioxide as sole whitening pigment.

6. The polyester film as claimed in claim 1, wherein the outer layer A is comprised of at least 90% by weight of copolymer and polyester.

7. The polyester film as claimed in claim 6, wherein the outer layer A is comprised of 100% by weight of copolymer and polyester.

8. The polyester film as claimed in claim 1, wherein the polyester of the outer layer A is a copolyester comprising ethylene terephthalate units and ethylene isophthalate units.

9. The polyester film as claimed in claim 1, wherein the outer layer A further comprises from 0.5 to 10% by weight of antiblocking agent.

10. The polyester film as claimed in claim 1, wherein said film further comprises an outer layer C and has an A-B-C layer structure.

11. The polyester film as claimed in claim 10, wherein the outer layer C is non-sealable.

12. The polyester film as claimed in claim 10, wherein the outer layer C comprises antiblocking agent.

13. The polyester film as claimed in claim 12, wherein the antiblocking agent is SiO₂.

14. The polyester film as claimed in claim 1, wherein said film has a minimum sealing temperature of the outer layer A with respect to nonpolar substrates of equal to or lower than 140° C.

15. The polyester film as claimed in claim 1, wherein said film has a seal seam strength of the outer layer A with respect to nonpolar substrates of greater than or equal to 1.5 N/15 mm of film width.

16. A process for producing a polyester film as claimed in claim 1 comprising the following steps:
a) producing a multilayer film by coextrusion,
b) biaxially orienting the coextruded film by stretching the coextruded film in the longitudinal and transverse directions, and
c) heat setting the stretched film.

17. The process as claimed in claim 16, wherein the longitudinal stretching is carried out at temperatures of from 60 to 95° C.

18. Packaging material for foods and other consumable items comprising polyester film as claimed in claim 1.

19. Packaging material as claimed in claim 18, wherein said packaging material is peelable film for food or drink containers.
